(19) United States
(12) Patent Application Publication
(10) Pub. No.: US 2024/0311619 A1
(43) Pub. Date: Sep. 19, 2024

(54) LANGUAGE ANALYSIS USING MACHINE LEARNING MODELS

(71) Applicant: University of South Florida, Tampa, FL (US)

(72) Inventor: John Licato, Tampa, FL (US)

(21) Appl. No.: 18/602,497

(22) Filed: Mar. 12, 2024

Related U.S. Application Data
(60) Provisional application No. 63/490,675, filed on Mar. 16, 2023.

(51) Int. Cl. G06N 3/0455; G06F 40/40

(52) U.S. Cl. CPC G06N 3/0455; G06F 40/40

(57) ABSTRACT

An example method includes receiving a text string; generating, by a first machine learning model, a feature values for the text string, where the feature values correspond to attributes of the text string; inputting the text string and the plurality of feature values into a second machine learning model; and generating, by the second machine learning model, a formal representation of the text string.

### CROSS-REFERENCE TO RELATED APPLICATIONS

This application claims the benefit of U.S. provisional patent application Ser. No. 63/490,675, filed on Mar. 16, 2023, and titled “AN ARTIFICIALLY INTELLIGENT HELPFUL RULES NAVIGATOR,” the disclosure of which is expressly incorporated herein by reference in its entirety.

### GOVERNMENT SUPPORT

This invention was made with government support under grant number FA8750-15-3-6003 awarded by the Air Force Office of Scientific Research, grant number FA9550-15-0001 awarded by the Air Force Office of Scientific Research, and grant number FA9550-20-F-0005 awarded by the Air Force Office of Scientific Research. The government has certain rights in the invention.

### BACKGROUND

Machine learning models can include language models, which include probabilistic models of natural language. Language models can be used to both generate new text and analyze the meaning of input text. Language models can be trained based on a corpus of input text that is related to the desired outputs of the language model. For example, a language model for software code can be trained using a corpus of software text.

Large language models are language models that extend the techniques of language models using large datasets. By training a language model using a large amount of text of different types, the language model can have the capability to analyze and output many different types of text. Large language models can require large amounts of memory and processing power to implement.

Improving machine learning models and language models, including large language models, can improve the analysis and generation of text.

### SUMMARY

Systems for training and implementing machine learning models for text analysis and generation are described herein.

In some aspects, the techniques described herein relate to a computer-implemented method including: receiving a plurality of text strings; generating a plurality of formal strings using a large language model (LLM), wherein each of the plurality of formal strings correspond to a text string of the plurality of text strings; generating a plurality of relationships that relate the plurality of formal strings; and generating, based on the plurality of formal strings and the plurality of relationships, a mapping of the plurality of formal strings.

In some aspects, the techniques described herein relate to a computer-implemented method, wherein the plurality of formal string include computer program code.

In some aspects, the techniques described herein relate to a computer-implemented method, further including displaying the mapping of the plurality of formal strings.

In some aspects, the techniques described herein relate to a computer-implemented method, wherein displaying the mapping of the plurality of formal strings includes displaying a flowchart, wherein the flowchart represents the plurality of relationships that relate the plurality of formal strings.

In some aspects, the techniques described herein relate to a computer-implemented method including: receiving a text string; generating, using a first machine learning model, a plurality of feature values for the text string, wherein the plurality of feature values correspond to attributes of the text string; inputting the text string and the plurality of feature values into a second machine learning model; and generating, by the second machine learning model, a formal representation of the text string.

In some aspects, the techniques described herein relate to a computer-implemented method, wherein the first machine learning model includes a lightweight model.

In some aspects, the techniques described herein relate to a computer-implemented method, wherein the first machine learning model includes a machine learning model fine-tuned to identify application programing interface (API) features.

In some aspects, the techniques described herein relate to a computer-implemented method, wherein the first machine learning model includes a lightweight large language model.

In some aspects, the techniques described herein relate to a computer-implemented method, wherein the first machine learning model is less complex than the second machine learning model.

In some aspects, the techniques described herein relate to a computer-implemented method, wherein the second machine learning model includes a large language model.

In some aspects, the techniques described herein relate to a computer-implemented method, wherein the plurality of feature values include API functions.

In some aspects, the techniques described herein relate to a computer-implemented method, wherein the first machine learning model includes a language capable model, computational language model, and/or Bidirectional Encoder Representations from Transformers (BERT) model.

In some aspects, the techniques described herein relate to a computer-implemented method of responding to natural language queries including: receiving a trained large language model; receiving a plurality of formal strings and a plurality of text strings, wherein each of the plurality of formal strings correspond to a text string of the plurality of text strings; receiving a natural language query; determining, based on the plurality of formal strings, a formal answer to the query, wherein the formal answer corresponds to a text string of the plurality of text strings.

In some aspects, the techniques described herein relate to a computer-implemented method, further including outputting the formal answer to the query for display.

In some aspects, the techniques described herein relate to a computer-implemented method, wherein further including outputting the text string of the plurality of text strings for display.

In some aspects, the techniques described herein relate to a computer-implemented method, wherein the formal answer further comprises a formal string of the plurality of formal strings that corresponds to the formal answer to the query.

In some aspects, the techniques described herein relate to a computer-implemented method, wherein the trained large language model is fine-tuned on a rule set.

In some aspects, the techniques described herein relate to a computer-implemented method, wherein the formal strings include logical outputs.

In some aspects, the techniques described herein relate to a computer-implemented method, wherein the natural language query includes a request to determine whether a formal string of the plurality of formal strings is related to the natural language query.

In some aspects, the techniques described herein relate to a computer-implemented method, wherein the formal strings include computer code.

It should be understood that the above-described subject matter may also be implemented as a computer-controlled apparatus, a computer process, a computing system, or an article of manufacture, such as a computer-readable storage medium.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 illustrates a system block diagram of a system for implementing machine learning techniques according to implementations of the present disclosure.

FIG. 2A illustrates a method for generating formal representations of a text string, according to implementations of the present disclosure.

FIG. 2B illustrates a method for generating a mapping of formal strings based on relationships between formal strings, according to implementations of the present disclosure.

FIG. 2C illustrates a method of determining an answer to a natural language query using formal strings, according to implementations of the present disclosure.

FIG. 3 illustrates an example method of fine tuning a lightweight language model to predict API calls and/or code snippets to develop prompts for a code generator model, according to implementations of the present disclosure.

FIG. 4 illustrates an example set of code/text pairs that can be used as an input to a code generator model, according to implementations of the present disclosure.

FIG. 5 illustrates example comparisons of models at different text word lengths, according to implementations of the present disclosure.

FIG. 6 illustrates an example result of training a classifier to predict interface symbols (ISes) according to implementations of the present disclosure.

FIG. 7 illustrates an example comparison of generated code to gold-standard code, according to implementations of the present disclosure.

FIG. 8 illustrates an example map and grid, according to implementations of the present disclosure.

FIG. 9 illustrates a compound action as a series of atomic actions.

FIG. 10 illustrates an example method including prompting users for actions which are allowed or disallowed, and user inputs of action utterances, according to implementations of the present disclosure.

FIG. 11 illustrates an example of disallowed action strings, according to implementations of the present disclosure.

FIG. 12 illustrates an example of experimental results including accuracy for different example implementations of the present disclosure.

FIG. 13 illustrates an alternative experimental result to the one shown in FIG. 12, according to implementations of the present disclosure.

FIG. 14 illustrates an example method for generating formal representations of text, according to implementations of the present disclosure.

FIG. 15 is an example computing device.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. Ranges may be expressed herein as from “about” one particular value, and/or to “about” another particular value. When such a range is expressed, an aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. While implementations will be described for generating formal analyses of rules, it will become evident to those skilled in the art that the implementations are not limited thereto, but are applicable for training and fine tuning other types of machine learning models.

Described herein are systems and methods generating and analyzing text.

Existing machine learning models, including language models and large language models, can be difficult to apply consistently due to their “black box” nature and the difficulty of coming up with consistent and formal inputs to those models. Likewise, existing machine learning models can fail to produce formal structured outputs that conform to the expectations of an operator or system designer. Implementations of the present disclosure improve the training, fine tuning, and deployment of machine learning models by adding structure to the inputs and/or outputs of deployed machine learning models. Implementations of the present disclosure further improve the efficiency of using deployed machine learning models. An example implementation of the present disclosure combines a lightweight machine learning model with a large language model, using the lightweight machine learning model to structure the inputs to the large language model and then using the large language model output a formal response based on the user's input and the analysis performed by the lightweight machine learning model. As described herein, a lightweight machine learning model can be a machine learning model that is less complex than a large language model. For example, the lightweight machine learning model can require less memory or processing power, and/or have fewer parameters than an LLM. The lightweight machine learning model can be a model that is lightweight in inference mode (less complexity used when it is deployed) and/or a model that is lightweight during training (less complexity used to train). Alternatively or additionally, example implementations of the present disclosure include techniques for structuring and analyzing formal data (e.g., the patterns in a simulation) using trained machine learning models. Methods of structuring the inputs to machine learning models improve the accuracy of those models by providing formal inputs that can be mapped to formal outputs (e.g., data to machine code). It should be understood that these example implementations are only non-limiting examples.

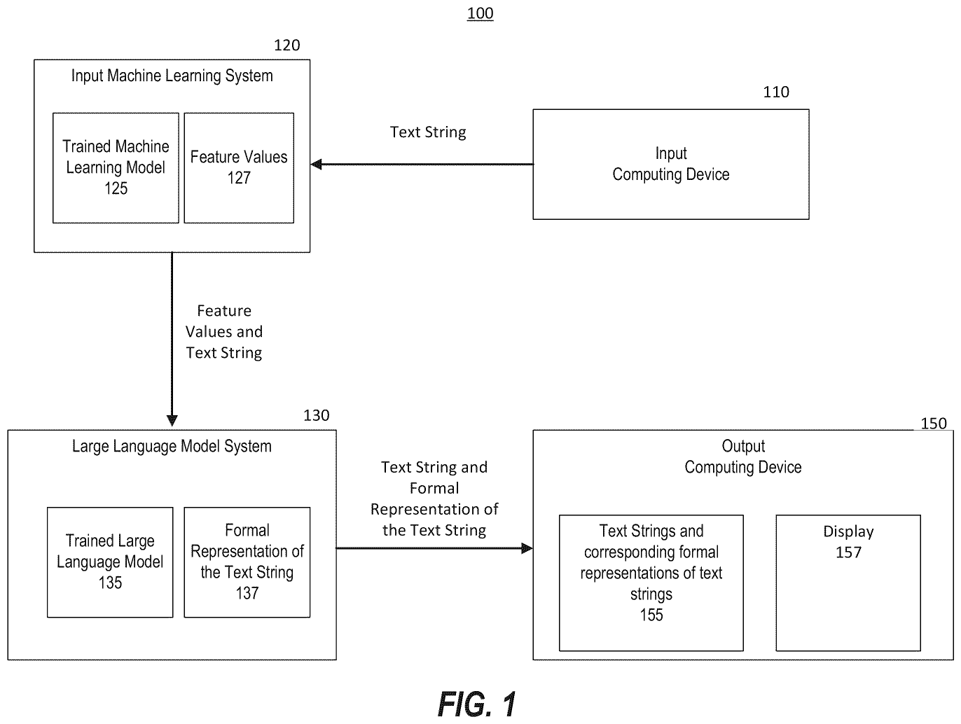

With reference to FIG. 1, a system 100 is shown according to an example implementation of the present disclosure. Example implementations of the present disclosure include systems that can analyze text strings in natural language that include logical relationships. For example, a text string describing a rule, a law, or a policy can be represent a logical relationship between inputs (e.g., actions that may be taken) and whether those actions are forbidden or allowed under the logical relationship. But it should be understood that implementations of the present disclosure can be configured to analyze text strings of any length, and in any context, and that implementations of the present disclosure are not limited to rules, laws, policies or other natural language logical relationships.

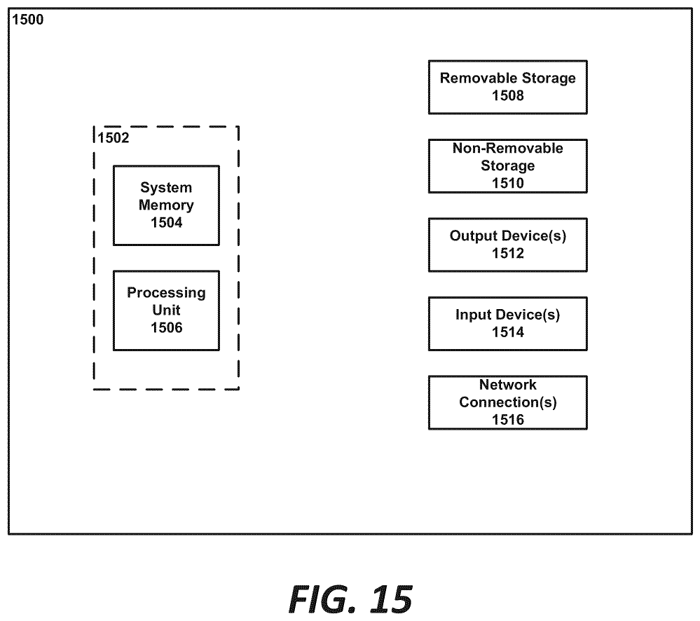

The system 100 includes an input computing device 110 configured to receive one or more text strings. The input computing device 110 can include any or all of the elements of the computing device 1500 described with reference to FIG. 15.

An input machine learning system 120 is configured to receive the one or more input text strings from the input computing device 110. The input machine learning system 120 can include any or all of the elements of the computing device 1500 described with reference to FIG. 15. The input machine learning system 120 can implement a trained machine learning model 125. The trained machine learning model 125 can be configured to identify feature values 127 for the input text string. The feature values 127 can include classifications of the text string, including what type of text string it is, and/or how the text string can be most accurately represented in a formal representation. As a non-limiting example, the feature values 127 can include functions or keywords that can be used as inputs to a larger model to configure the larger model to output a more accurate response.

The feature values 127 can be output to a large language model system 130 with the text string(s) that were received by the input machine learning system 120. The large language model system 130 can include any or all of the elements of the computing device 1500 described with reference to FIG. 15. The large language model system 130 can implement a trained large language model 135. The trained large language model 135 can be configured to receive an input (e.g., a prompt) that includes both the text string(s) and the feature values 127 determined by the trained machine learning model 125 for that text string. The trained large language model 135 can be configured to output, in response to the input text string(s) and feature values 127 one or more formal representations of the text string(s) 137. The formal representation of the text string 137 can include code (e.g., computer code or any other formal code). The large language model system 130 can output the text string and/or formal representation of the text string to an output computing device 150. The output computing device 150 can store any number of text strings and the corresponding formal representations of the text strings 155. The output computing device can further be configured to display formal representations of the text string, and/or the text strings themselves (e.g., the formal representations of the text strings arranged alongside the text string they represent). The output computing device 150 can include any or all of the elements of the computing device 1500 described with reference to FIG. 15.

Optionally, the output computing device 150 and input computing device 110 can be the same computing device in some implementations of the present disclosure. Optionally, the output computing device 150 and input computing device 110 can be the different computing devices in some implementations of the present disclosure. Alternatively or additionally, each of the output computing device 150, input computing device 110, input machine learning system 120, and large language model system 130 can each be linked directly or indirectly, for example by one or more communication links. This disclosure contemplates the communication links are any suitable communication link. For example, a communication link may be implemented by any medium that facilitates data exchange including, but not limited to, wired, wireless and optical links. Example communication links include, but are not limited to, a LAN, a WAN, a MAN, Ethernet, the Internet, or any other wired or wireless link such as WiFi, WiMax, 3G, 4G, or 5G.

In some implementations of the present disclosure, the system 100 is configured so that the large language model system 130 can be implemented as part of a cloud or other networked system remote from the input machine learning system 120, input computing device 110, and/or output computing device 150. Implementations of the present disclosure can allow for a trained machine learning model 125 to be trained using simpler and less expensive hardware systems, which can then be used to indirectly “fine tune” the trained large language model 135 using feature values 127 that are configured to improve the outputs of the trained large language model 135.

Optionally, the trained machine learning model 125 is a lightweight machine learning model that is configured for efficiency and cost. As used herein, a “lightweight machine learning model” is a machine learning model that is less complex than the trained large language model 135 (e.g., the lightweight machine learning model has fewer parameters, takes up less memory, uses less processing power to train, and/or uses less processing power run in inference mode). In some implementations, model parameters are used to measure complexity. For example, the trained machine learning model 125 can include fewer model parameters than the trained large language model 135, and therefore the trained machine learning model 125 is less complex than the trained large language model 135. It should be understood that model parameters are provided only as an example measure of complexity. Other non-limiting factors that can be used to measure complexity include memory usage, computational complexity (e.g. number of computations), processing time, processing power. Additionally, it should be understood that complexity may be measured for training mode, inference mode, or both.

Alternatively or additionally, in some implementations, complexity is measured by the memory required for training mode, inference mode, or both. For example, the trained machine learning model 125 can require less memory than the trained large language model 135 to operate in inference mode. This can allow the trained machine learning model 125 to be operated using simpler and/or less complex hardware. For example, the trained machine learning model 125 can be operated locally on a local device, while the trained large language model 135 can be a remote device in communication through a network with the trained machine learning model 125 on the local device.

As another example, because the trained large language model 135 can require more memory to train than the trained machine learning model 125, the trained machine learning model 125 can be locally trained or fine-tuned to optimize its performance (e.g., improve the accuracy of its responses to certain inputs or types of data).

As still another example, because the trained large language model 135 can require more processing power to operate than the trained machine learning model 125, the trained large language model 135 can be less efficient than the trained machine learning model. The processing power required for a model can scale with the number of inputs to the model. Implementations of the present disclosure improve the quality of inputs to the trained large language model 135 by using the trained machine learning model 125 to generate features that allow the trained large language model 135 to generate correct responses without requiring repeated inputs (e.g., prompts)

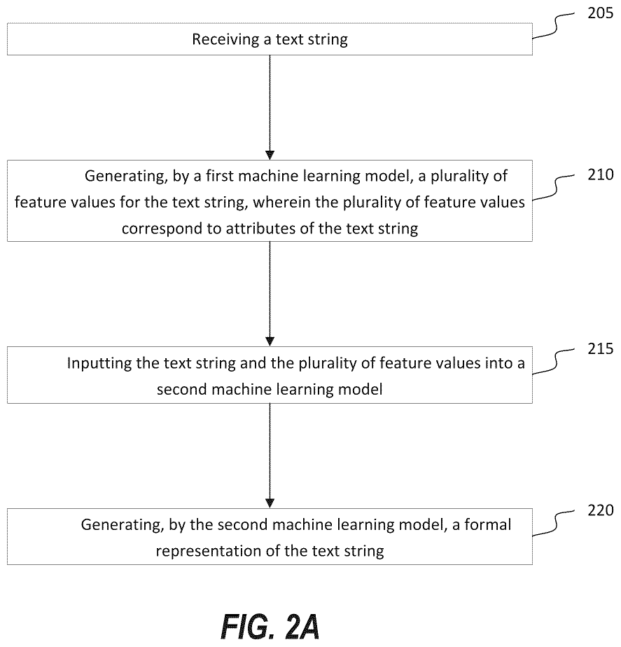

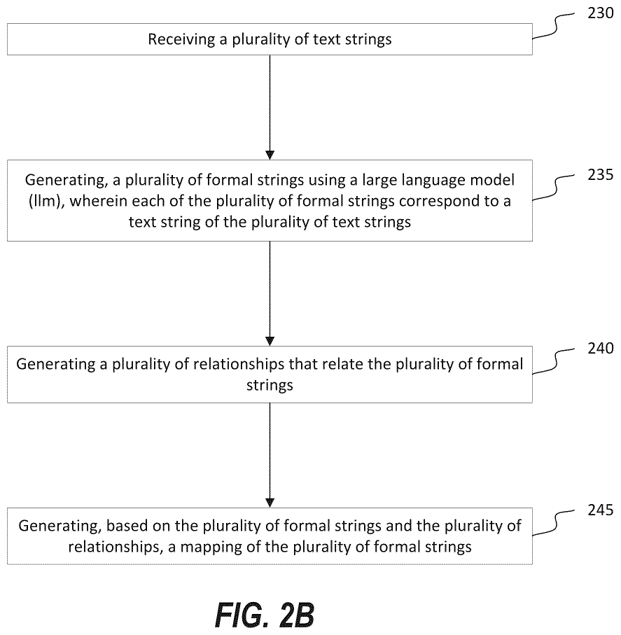

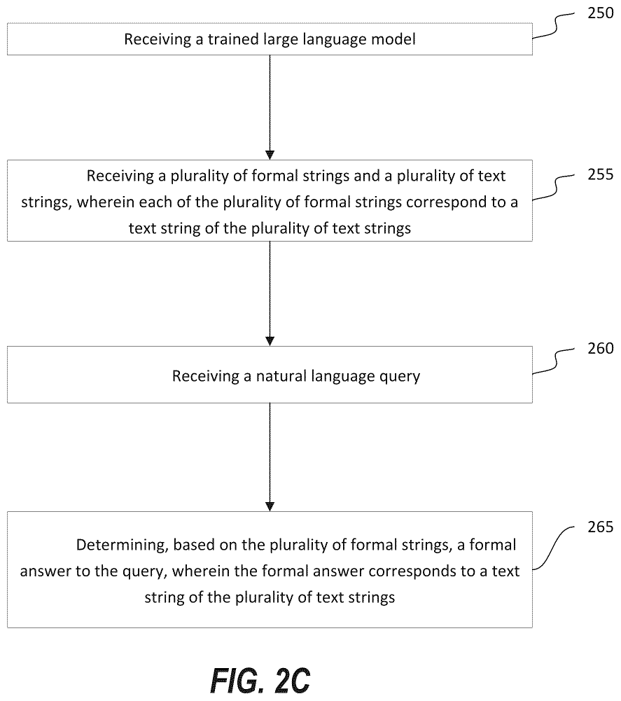

With reference to FIG. 2A, implementations of the present disclosure include computer-implemented methods of using lightweight machine learning models in combination with large language models to improve the analysis of text.

At step 205, the example method includes receiving a text string.

At step 210, the example method includes generating, using a first machine learning model (e.g., the trained machine learning model 125 of the input machine learning system 120 shown in FIG. 1), a plurality of feature values for the text string, where the plurality of feature values correspond to attributes of the text string.

As described with reference to FIG. 1, the first machine learning model can optionally be a lightweight machine learning model or lightweight large language model. In some implementations of the present disclosure, the first machine learning model is fine tuned to generate feature values for a specific use case. For example, the first machine learning model can be fine tuned to identify an application programming interface, or feature of an API that most closely relates to the text string.

In some implementations of the present disclosure, the first machine learning model includes a Bidirectional encoder representations from transformers model. It should be understood that the Bidirectional encoder representation is intended only as a non-limiting example. The present disclosure contemplates that BERT, or a BERT-like system can be used, however the present disclosure also contemplates that the first machine learning model can be any computational language model or language capable model. It should be understood that while BERT is an example of a computational language model and a language capable model, computational language models and language capable models include models with different architectures and capabilities from BERT.

At step 215, the example method includes inputting the text string and the plurality of feature values into a second machine learning model. As described with reference to FIG. 1, the second machine learning model can be a large language model (e.g., the trained large language model 135 shown in FIG. 1). As described above, the second machine learning model can be more complex that the first machine learning model.

At step 220, the example method includes generating, using the second machine learning model, a formal representation of the text string. Optionally, a set of formal representations of text strings can be used to identify relationships between the text strings. For example, two text strings can have an identical formal representation, indicating that those text strings are redundant, or one text string can output a value that is the input value of another text string. By representing the text strings in formal representations, the relationships between the text strings can be mapped and analyzed. Optionally, the relationships between the text strings, and/or the text strings and their corresponding formal representations of the text strings, can be output to a display (e.g., the display 157 of the output computing device 150 shown in FIG. 1).

With reference to FIG. 2B, implementations of the present disclosure include methods of determining relationships between text strings using formal representations of those text strings.

At step 230 the example method includes receiving a plurality of text strings.

At step 235 the example method includes generating a plurality of formal strings using a large language model (LLM), where each of the plurality of formal strings correspond to a text string of the plurality of text strings. As described with reference to FIGS. 1 and 2A, the plurality of formal strings can optionally include computer program code.

At step 240 the example method includes generating a plurality of relationships that relate the plurality of formal strings.

At step 245 the example method includes generating, based on the plurality of formal strings and the plurality of relationships, a mapping of the plurality of formal strings. Optionally, the mapping of the plurality of formal strings can be displayed (e.g., by the display 157 shown in FIG. 1). A non-limiting example of displaying the mapping of the formal strings includes representing the formal strings as a flowchart, where the flowchart represents logical relationships between the text strings.

With reference to FIG. 2C, implementations of the present disclosure include methods of processing natural language queries using formal representations of text strings.

At step 250, the method includes receiving a trained large language model.

At step 255, the method includes receiving a plurality of formal strings and a plurality of text strings, wherein each of the plurality of formal strings correspond to a text string of the plurality of text strings.

As described with reference to FIGS. 1-2B, the formal strings can include computer code that represents natural language in the text strings.

At step 260, the method includes receiving a natural language query. As used herein, a natural language query can include different questions or test cases for the text strings. As a non-limiting example, the natural language query ask whether an action is permitted by, or not permitted by the text strings. As another example, the natural language query can ask whether an action is contained within the text strings. For example, if the text strings include a list of natural language rules, the formal representations can represent each rule as a logical relationship in formal language (e.g., computer code).

At step 265, the method includes determining, based on the plurality of formal strings, a formal answer to the query, where the formal answer corresponds to a text string of the plurality of text strings. Implementations of the present disclosure improve the analysis and/or response to queries by using the formal strings to answer the natural language queries. Optionally, the query can be structured as a formal query (e.g., a logical statement or code statement), or converted into a formal query by a trained machine learning model (e.g., an LLM).

As described with reference to FIG. 1, implementations of the present disclosure can be configured to display inputs and/or outputs to a user. In some implementations, the method can include outputting the answer to the query for display. Alternatively or additionally, the answer to the query can be displayed with the text string of the text strings that is related to the query. Alternatively or additionally, the answer to the query can be displayed with the formal representation of the text string that is related to the query. Therefore the output displayed to a user can be traceable and/or validated in ways that would not be possible using only an LLM to answer queries.

As a non-limiting example, the text strings in the method shown in FIG. 2C can be a set of rules that describe whether a user or system can take certain actions. The set of rules can be written in natural language. The formal representation of the rules can convert that set of rules into a set of code statements that formally represent the natural language rules. A user can query the set of rules to ask whether an action is permitted, and the method can include checking whether any of the formal representations of the rules are related to that action. If they are, the formal representation of the rule related to the action can be used to output an answer to whether the action is permitted (e.g., true or false). The system can also output the natural language text string used to generate the formal representation of the rule related to action A. Alternatively, or additionally, the query can be a request to determine if any rule is related to an action, and if any of the formal representations of the text strings include that action, then the system can output the formal representation of the text string, and/or the natural language text string used to create the rule.

Optionally, the large language model can be a model fine tuned on a rule set or other text strings including natural language text.

### Example 1

An example implementation of the present disclosure was configured for interpreting natural language into formal descriptions, including code. The example implementation was configured to determine formal representations of cards in a collectable card game (CCG).

Large pre-trained language models (LMs) such as GPT3 Codex can generate code prompts of natural language text. But using such LMs to generate code compatible with a specific API or library (e.g., an API which provides the environments in which certain rules, laws, or orders are to be carried out), can require a prohibitive amount of computational and data resources required to fine-tune such models. Implementations of the present disclosure include algorithms that select code examples using a less complex LM trained to predict which features of an API are likely to be used in the resulting code, which is a simpler problem than actually generating the code. The selected examples are then used to build a prompt for the larger LM, which in turn generates the final code. The results are demonstrated on a benchmark dataset derived from the collectible card game “Magic: the Gathering.”

The example implementation was configured to generate code for rules and attributes of the Magic: the Gathering™ (MtG) card game. In such games, players have a set of cards they can play, each of which may have text describing possible effects of those cards. Some of these effects might be simple and unambiguous (e.g., “When this card is played, the opposing player takes 5 damage.”). However, cards can contain language that is open-textured—i.e., language whose full domain of applicability is underspecified, often by design (Hart 1961; Waismann 1965; Vecht 2020). Correctly interpreting open-textured language in CCGs can require a deep knowledge of the game, how the card and the language used in the text has historically been interpreted, the ramifications of adopting one interpretation over another, and so on. These problems parallel those faced by the automatic interpretation of law (Bench-Capon and Sergot 1985; Sanders 1991; Franklin 2012; Prakken 2017; Quandt and Licato 2020); in fact, the rules and conflict resolution systems of MtG has been described as an entire legal system in and of itself, complete with judges who must make rulings based on precedent, established best practices for interpretive reasoning, and commonsense notions of fairness (Adler 2019). As such, the problem of how to automatically translate the text on MtG cards (and CCGs in general) into programming language code is a productive way to tackle the larger problem of automated reasoning about legal text, since converting the text into code requires generating a formal model for how the text is to be interpreted.

The problem of how to automatically interpret language in a way that produces a scrutable, understandable interpretation is of fundamental importance for the future of AI. Given text to be interpreted by an AI, human stakeholders need to be able to inspect: (I1) how the AI interpreted that text, and (I2) how the AI system determined that interpretation is best. (Licato 2021; Sartor et al. 2014; Walton, Sartor, and Macagno 2018; Licato, Marji, and Abraham 2019; Walton, Macagno, and Sartor 2021; Araszkiewicz 2021), but in this paper we will focus on (I1).

Implementations of the present disclosure include automatic code generation, which can include generating code representations of laws, rules, and other similar text. As a non-limiting example, CCGs such as Magic: the Gathering (MtG) include complex rule sets written in natural language, which can be challenging for computers to generate formal representations of. In CCG's, actors have a set of cards they can play, each of which may have text describing possible effects of those cards. Some of these effects might be simple and unambiguous (e.g., “When this card is played, the opposing player takes 5 damage.”). But it is very common for cards to contain language that is open-textured—i.e., language whose full domain of applicability is underspecified, often by design (Hart 1961; Waismann 1965; Vecht 2020). Correctly interpreting open-textured language in CCGs can require a deep knowledge of the game, how the card and the language used in the text has historically been interpreted, the ramifications of adopting one interpretation over another, and so on. As such, the problem of how to automatically translate the text on MtG cards (and CCGs in general) into programming language code is an example of automated reasoning about legal text, since converting the text into code requires a system that can make interpretive determinations about the meaning of the text.

Automatic Code Generation Generating programming code from a mixed input of natural language text and structured prompts is a difficult challenge even for state-of-the-art language models. Models for code generation largely focused on syntactically matching gold-standard code, without regard for functionality. This creates a deficiency where such models are not able to innovatively generate code that is syntactically different, but functionally equivalent to the gold standard. This is particularly salient for the generation of code from CCG card effects, as many keywords may produce similar effects with varying magnitudes and differing game-specific keywords across CCGs may produce the equivalent or near-equivalent effects. Evaluation metrics such as CodeBLEU (Ren et al. 2020) attempt to address the functionality problem by weighting the BLEU score for assessing multiple “translations” along with the syntactic abstract syntax tree match, but this still prefers predictions that are formatted similarly to the gold standard and underperforms human judgment on choosing effective code (Evtikhiev et al. 2022). The challenge of generating code for card effects in CCGs is further exacerbated due to fact that many cards may contain “flavor text,” e.g., text that does not modify the card's effects in any way, but is used to provide narrative elements to the CCG.

Latent predictor networks may be unable to generalize natural language terms outside the scope of game-specific keywords and, therefore, produced high inaccuracies when presented with card effects it had not previously seen. (Ling et al. 2016). Further, they did not address functional correctness, as generated code that was functionally equivalent but syntactically different from correct code may have been marked as incorrect.

Current models have focused on addressing the functionality concern (Zhong, Yu, and Klein 2020; Rajkumar, Li, and Bahdanau 2022). The CodeGen-Test model (Zhong et al. 2022) implements a code testing step in the model training and backpropagates the results of the tested code along with the syntactic similarity metrics. The model was found to outperform the existing state-of-the-art models in similarity as measured by BLEU, which performs poorly in differentiating code, and Rouge-L, which is better at emulating human judgment (Evtikhiev et al. 2022). Furthermore, it also significantly outperformed those same models in functional correctness.

With the growth of large language models (LMs), even the process of fine-tuning has become computationally expensive to the point of infeasibility for many tasks. However, methods to teach these models to perform specific tasks are still necessary. Therefore methods of improving the prompts or other inputs to the LMs can be used to adjust the outputs of the model without engaging in computationally expensive fine tuning. Prompts can also be fine-tuned by feeding them into language models and adjusting the prompt based on the output received.

OpenAI's GPT-3 Codex (Chen et al. 2021) was trained on code from Github and performed at state-of-the-art levels in code generation tasks. Codex produced significantly improved results on HumanEval for measuring functional correctness, compared to GPT-3 and GPT-J. Subsequent models which use prompting to build on top of Codex and generate SQL code have shown further improvements in fluency (Scholak, Schucher, and Bahdanau 2021; Poesia et al. 2022) and adequacy (Rajkumar, Li, and Bahdanau 2022; Trummer 2022). Codex is able to take, as its input prompt, code examples or human-understandable text describing code to be written.

However, prompt and input limitations of LMs can prevent an input from including exhaustive instructions or an entire rulebook. For example, a LM may have a limitation that the size of the prompt plus the maximum output size is roughly 8,000 tokens (each token is roughly 3 characters). But this prompt size is not large enough to teach Codex how to use the massive XMage API that is in excess of 8,000 tokens in length. And fine-tuning Codex is simply not plausible for multiple reasons: GPT-3 is not publicly released, and even if it were, it requires massive computational capabilities far beyond that of most organizations. Implementations of the present disclosure include methods of generating formal prompts for LMs without fine tuning the LMs themselves.

Attempts have been made to digitize MtG via the open-source XMage client, but the XMage implementation is large and not straightforward to automate: every single card type has at least one Java class, every possible effect has at least one function call, etc. Despite these complexities, since the benchmark dataset established by (Ling et al. 2016) uses XMage as its implementation, and this is the only existing benchmark dataset for MtG code generation, that benchmark is referred to herein.

Automatic generation of code from card text is a difficult problem to solve, in part because the APIs used to implement CCGs often have too many features to learn without fine-tuning. However, fine-tuning state-of-the-art code generating language models is often not computationally feasible.

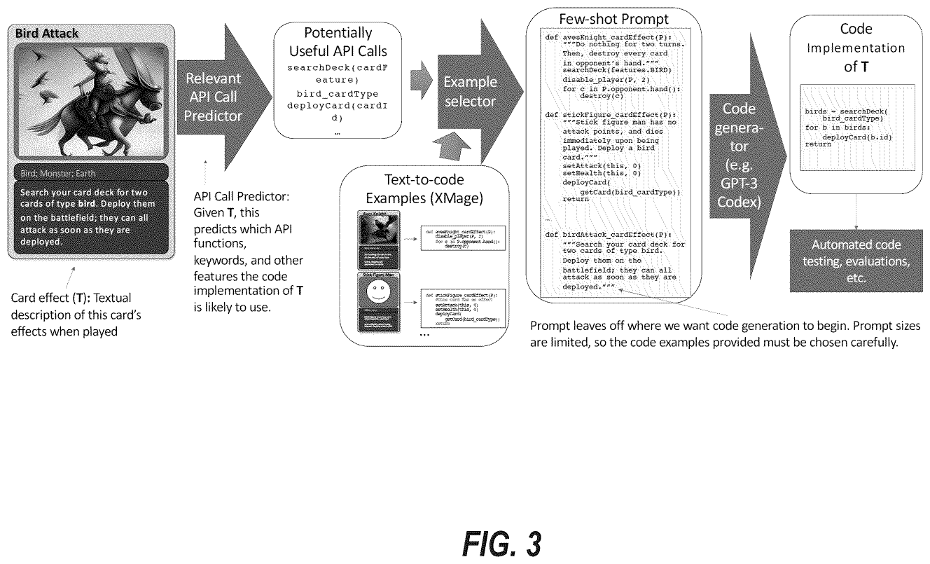

An example implementation includes fine-tuning a smaller LM (e.g., ROBERTa-Large) not to directly write the code to implement a card's text, but to predict which API features the code is likely to use (referred to in the present example as “Stage 1”). These predictions can then be used by a system to select examples of previously written code to build a prompt for a larger LM (e.g., GPT-3 Codex). The intuition behind this is that the larger LM simply needs examples of how to use the API features it is likely to use. The LM then writes the code (referred to in the present example as “stage 2”). An example method is pictured in FIG. 3. The results of the present example on the Card2Code XMage benchmark (Ling et al. 2016) show improved performance beyond existing methods and systems.

Example Stage 1: Predicting API Identifiers. “Stage 1” includes training a classifier to predict, given the text of a card, which API-specific features the code implementation of that text in the API is likely to use. Interface symbols (ISes) are defined as the set of symbols that are specific to a given API: class names, enumerated types, function names, etc. In the present example, the ISes are of the XMage API, which was written in Java, but it should be understood that the Ises can include any programing language and/or API. The example set of ISes does not include strings, literals, or language-specific keywords (class, if, else, etc.). If the example classifier were able to determine which ISes would be needed, the example implementation could select example code to include in the prompt that demonstrates how to use the ISes properly.

Dataset construction. Using the code as part of the XMage training set, the study extracted a list of ISes, resulting in 2,712 unique symbols. Note that this large number of unique symbols is so large, that fully teaching an LM how to use the API cannot be reasonably done without significant finetuning, which—for state-of-the-art code generation models like GPT-3 Codex—is computationally infeasible for most organizations. Given the list of ISes, the study constructed a IS dataset consisting of triplets (T, k, p), where: T is the text of some card in the XMage training set; k is an IS; p∈{0,1} is 1 if the code implementation of T contains k, 0 otherwise.

For each (T, k, p) where p=1, the study randomly selected a k′ such that (T, k′, 0) could be inserted into the dataset, thus keeping the dataset balanced. The resulting dataset was divided into a training set with over 303 K items, and dev and test sets each with over 16 K items. The study then trained ROBERTa-Large on the dataset to predict p given (T, k), and achieved over 90% accuracy. The trained model could then be used to predict which keywords appear in the text implementation for any given text T by giving it (T, k) as input for all k and predicting the set of words k for which the model returned a value of 1.

Baselines. In order to evaluate whether the trained model was able to predict ISes better than random models, the study created multiple baselines. The hyperparameters in the base-lines that follow were chosen through grid search, and for space herein only report values that are of interest are reported:

Pure Random (PR): For each IS, the study includes that IS with p % probability (p∈{10,50,90}).

Random by Frequency (RF): The study analyzed the XMage training set, and determine the document frequency of each IS (the percentage of code examples in which the IS appears). For each IS, its document frequency is then multiplied by λ∈{3,5,10}, and the resulting value is the probability with which the study includes the IS. The parameter size of Δ=5 was chosen as it made the average number of ISes per text input almost the same as that of ROBERTa-Large.

Simple Similarity (SS): To examine the possibility that ROBERTa-Large is simply learning to select ISes that have similarities to words in the original card text, this SS model predicts an IS if is either a strict substring of, or has as a substring, a word in the card text.

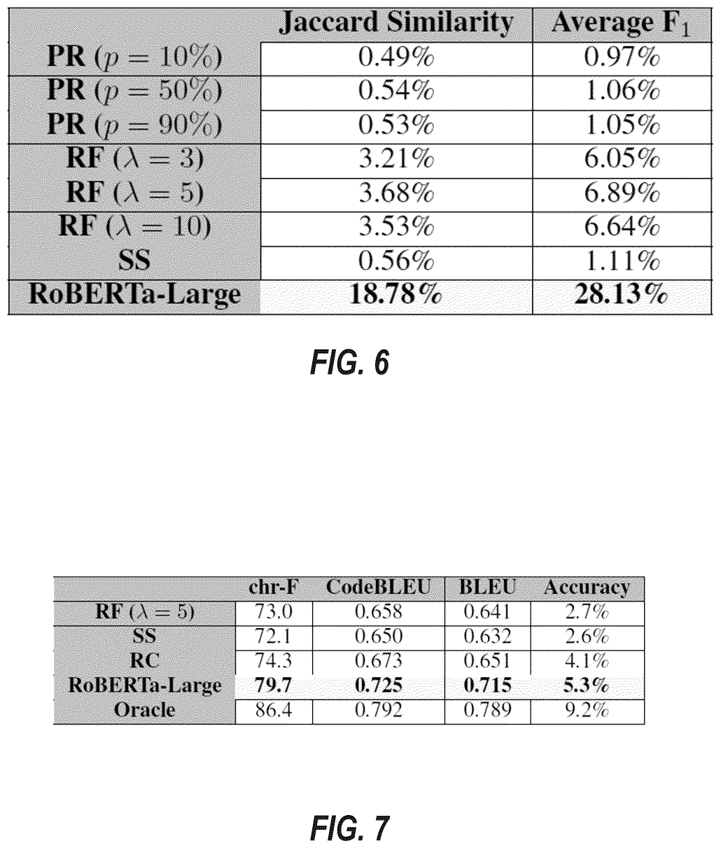

Results. Because the number of ISes that actually appear in each card's code is very low compared to the number of possible ISes (roughly 45 versus 2,712), any model that predicts that no ISes should be included would be given a high accuracy, meaning it is not a useful measure here. The study reports two measures: Jaccard similarity and Average F₁ score (F₁ score for each instance, averaged over all instances). Results are listed in FIG. 6, showing that the ROBERTa-Large model outperforms the comparisons.

In order to determine whether ROBERTa-Large is simply learning to predict ISes that appear frequently, the study compared the set of ISes predicted by ROBERTa-Large and RF (λ=5). The average number of ISes predicted by these models were 159.3 and 136.6, respectively (compare this to the correct number of ISes which was on average 44.97), but the average about of ISes predicted by both models was only 16.45. This suggests that ROBERTa-Large is using a different heuristic to select ISes than simply IS frequency, and perhaps that a hybrid approach leveraging both approaches may yield improvements.

Example stage 2: Generating Code from Predicted Identifiers, Prompt Construction. Given a model that can predict which ISes will be used in the generated code, our next step is to actually generate that code. The study use GPT-3 Codex (Chen et al. 2021), which allows a total of 8,000 tokens for both the input prompt and the returned tokens (for reference, each token is roughly 3.1 characters on average). Since the largest code examples from the XMage training set were around 1500 tokens, the study allocated 6500 tokens to construct a prompt that provides sufficient examples to teach Codex how to use the predicted ISes.

Given a card text T, and predicted ISes IS, the study selected code snippets cᵢ, where each cᵢ consists of a Java comment stating the original card text that this code implements, and the Java code implementation itself (departing from the original work in (Ling et al. 2016), the study rewrote card properties in a more human-friendly format, and restore line breaks into the Java code, in order to better match the human-readable comments in the corpus Codex was trained on). All c; come directly from the XMage training set, which contains roughly 120 K items. Furthermore, all of the c; concatenated must have a total length of 6500 tokens or less. The example implementation can then be framed as an instance of the weighted set cover problem, as the study selects a set of cᵢ where the weight w(cᵢ) of each item is the number of tokens of cᵢ, and the value v(c₁ ∪ . . . ∪ cₙ) is the number of k∈(c₁ ∪ . . . ∪ cₙ) that are also in IS.

Although the weighted set cover problem is known to be NP-hard, approximation algorithms exist. The study used the greedy algorithm by (Chvatal 1979) as an example, which returns a set cover of weight at most Σᵢ₌₁^{m} 1/m times the minimum weight of the optimal cover, where m is the largest set size (in our case, the c; with the largest number of tokens). To summarize the greedy algorithm: suppose at any iteration we have a current prompt P, consisting of the concatenation of cᵢ included. The scores of each cᵢ are calculated as:

$$\frac{w ( {c}_{i} )}{v ( P ⋃ {c}_{i} ) - v ( P )} if w ( P ⋃ {c}_{i} ) < 6500 , else ∞$$

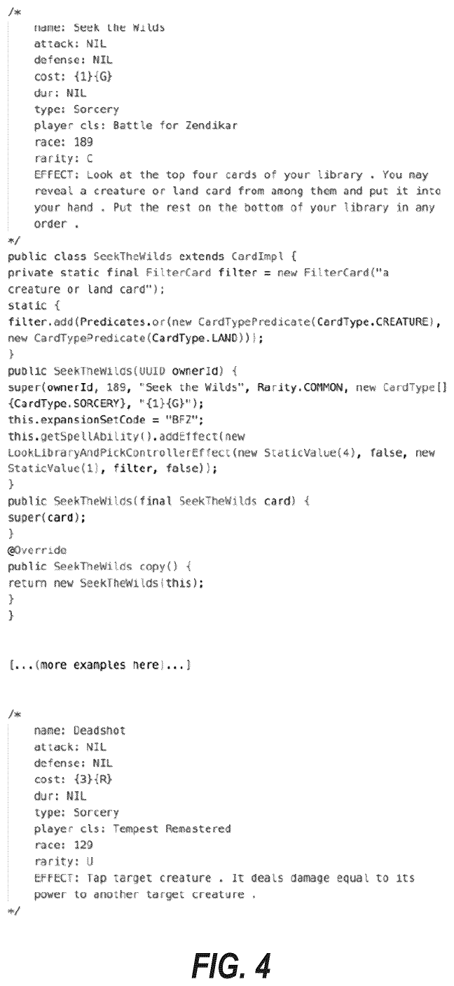

The study selects the cᵢ whose score is smallest and concatenate it to P. If all scores are ∞ then terminate. Finally, a comment is appended to P containing the text that GPT-3 should write the code for, as shown in the example string in FIG. 4.

Baselines. In Stage 1, the Random by Frequency (RF) baseline with λ=5 performed second-best to ROBERTaLarge, and the Simple Similarity (SS) baseline was the next best performer out of those using non-RF strategies. The study selected those two baseline models to compare with RoBERTa-Large. The study also used use a Random Codelet (RC) baseline, which did not use ICs at all, and instead randomly selects code examples from the training set until the token limit is reached. Finally, for the purposes of comparison, the study introduced an Oracle baseline which doesn't try to predict the ISes which will appear, but actually uses the correct ISes from the XMage dev and test sets. The inclusion of the oracle is done to show the improvement in performance using the IS model from Stage 1.

The prompts from the example four models are input to GPT3 Codex, and the generated code is compared to the correct code using four metrics: Chr-F score, a comparison of n-gram overlap which was recently recommended for use in comparing code after an analysis of similar methods (Evtikhiev et al. 2022); BLEU, typically used for comparing text similarity in language translation; CodeBLEU (Ren et al. 2020), which is an extension of BLEU score designed to compare code; and accuracy, which is true only if the generated code exactly matches the reference code.

### Example Results

Comparison of the example ROBERTa-Large approach and baselines is in FIG. 7. The example implementation outperforms all others (recall that Oracle knows in advance which ISes are correct, and is included as an upper limit), but not by a large amount. Perhaps the most informative of these four metrics is the CodeBLEU metric, as it specifically takes into account code-specific syntactic features (the others rely on n-gram overlap or exact character match). The results compare favorably to those reported by the best performing models in (Ling et al. 2016), which were 0.614 (BLEU score) and 4.8% (Accuracy), but it is important to note that the results were reported on the dataset's test set, whereas the example implementation results were on its validation set.

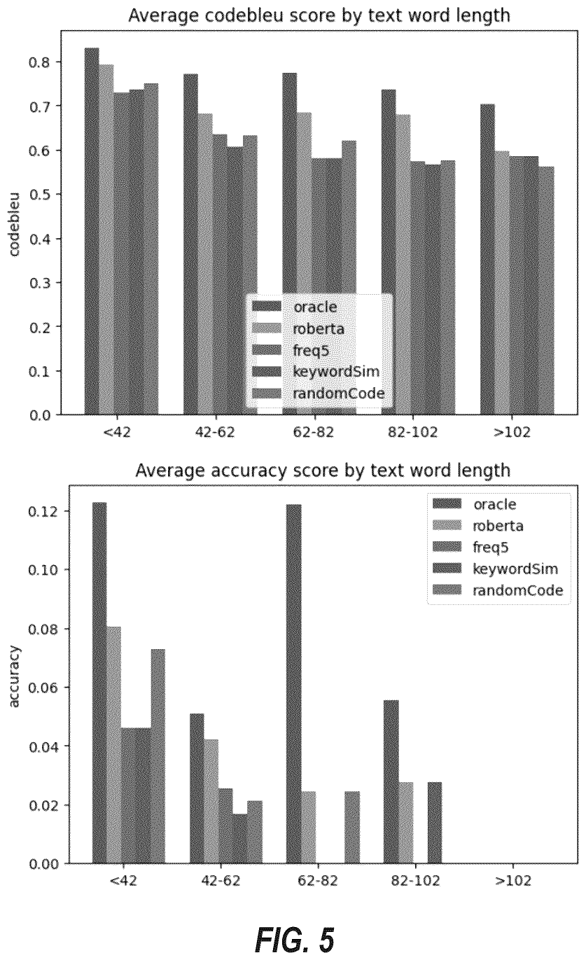

Some cards contain effects that have only a single word (e.g., “Haste.”), whereas others have lengthy descriptions with complex conditionals. To study the effect of this difference, FIG. 5 shows the scores of each code generation model when broken down based on the number of words in the original card text. Although the study only shows these breakdowns for codebleu and accuracy for space reasons, the overall pattern is repeated across all four measures: our ROBERTa-Large model slightly outperforms or matches all other models except for Oracle, but the advantage ROBERTa-Large has over the other models disappears with larger text sizes. For card text with more than 102 words, not a single model is able to achieve full accuracy, showing that existing approaches are still quite limited.

The example implementation approach outperforms other comparisons, and elicits state-of-the-art performance from the large GPT-3 Codex LM, without requiring Codex to be fine-tuned. However, the example implementation can be further improved by improvements to dataset and training design. For example, the keyword similarity-based classifier errs on the side of predicting fewer keywords (more false negatives), the ROBERTa-based classifier errs on the side of predicting more keywords than needed (more false positives). Implementations of the present disclosure include classifiers that include combinations of the ROBERTa and keyword classifiers to improve the rates of false positives and negatives.

The example prompt given to Codex can provide examples of how to write code utilizing the predicted ISes. However, instead of providing examples for use, implementations of the present disclosure can use the prompt as a way of explicitly providing instructions on how to use those Ises. At present, the XMage code base doesn't have sufficient documentation for each possible IS, but alternative datasets and applications can include explicit instructions provided via prompt.

Example 2: A study was performed using implementations of the present disclosure to perform rule analysis using machine learning models, including large language models. Given a set of rules expressed in real-world regulatory language and an action, can state-of-the-art large language models determine whether the action is permissible? If not, why not, and what additional information is needed before they can perform this task well? These questions are of significant interest for developing machine learning models that can be used for applications requiring consistent formal outputs. Existing work studying how well LMs can interpret those rules focuses on a narrow set of domains, with little focus on cases where those rules have the complexity of real-world legal systems.

An example implementation of the present disclosure includes LLMs configured to analyze a dataset (e.g., the benchmark, dataset herein from a board game (“BG”) selected for the complexity of its rule set). The study included the effects of shot size, function calls, and example rationales on the quality of reasoning about action permissibility.

Natural language text can include a certain amount of ambiguity, including open-textured term used to allow a certain degree of decision-making flexibility to those who must interpret and apply the rules, [Hart, 1961; Waismann, 1965]. For AI agents to follow human laws, rules, and commands, and interpret them in human-like ways, AI systems can include alignment between how AI interprets rules with open-textured terms and how humans do. [Franklin, 2012; Prakken, 2017; Quandt and Licato, 2020; Licato et al., 2019; Licato and Marji, 2018].

Organizations are using open-textured rules that LMs themselves must interpret to constrain and regulate the behaviors of either themselves or other LMs (e.g., “Guardrails” [Rebedea et al., 2023] and “Constitutional AI” [Bai et al., 2022]), using benchmark datasets of toxicity or ethical behavior as the primary measures of success.

The domain of complex BGs is fruitful and underutilized for studying this problem. GMT's Next War: Taiwan (NW:Taiwan) [Land, 2014] is a large war-based BG with functionality for ground, air, and naval warfare. It includes a standard and advanced set of rules which are used in the entire Next War series and an additional, supplementary set of rules that are specific to the variant (in this case Taiwan). The study created a dataset of complex scenarios and actions, designing a new data collection procedure to do so.

The present example includes a new dataset for a complex BG with a naturalistic rule set containing realistic open-textured language; a methodology for collecting datasets of this type, developing a set of functions that an LM can use to query BG state, etc.; and an investigation into the extent to which the ability to query BG state affects LMs' ability to reason about action permissibility.

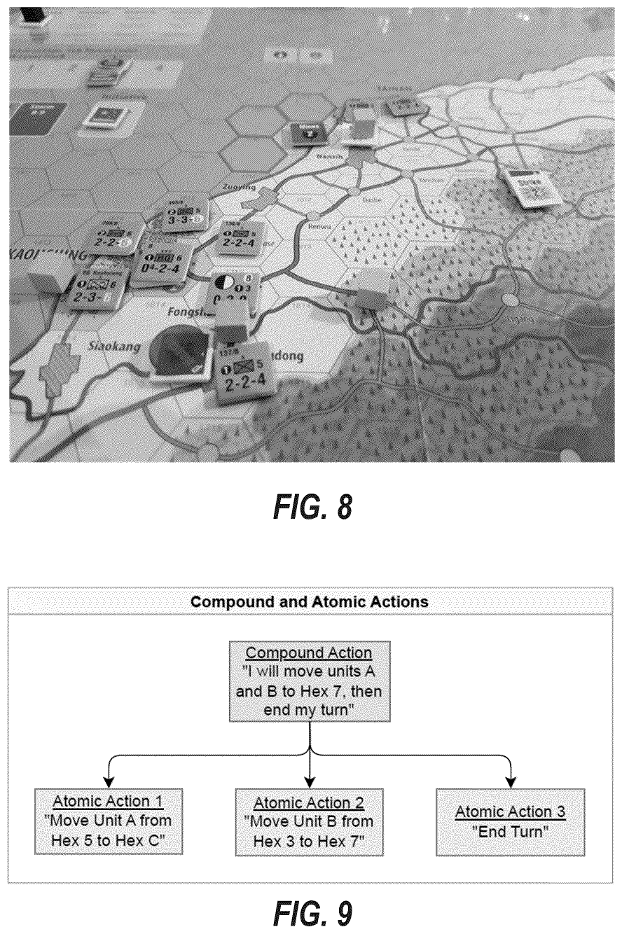

Dataset creation. The example described in the present study includes the creation of a rigorous, methodically verified, benchmark dataset for rule reasoning. This dataset consists of scenarios in a simplified version of NW: Taiwan, and actions in those scenarios expressed in language that are either permitted by the rules, or not permitted. NW:Taiwan is a BG where two actors vie for control of Taiwan by sending troops into battle as either the People's Republic of China (China) or the Republic of China (Taiwan & Allies) [bgg, 2023]. There are locations spread over a geographic map of Taiwan broken down into hexagons (hexes) representing 7.5 miles. An example view of a hex map is shown in FIG. 8. Each actor begins the BG with a certain number of units and an objective, both of which are determined by the scenario. Additionally, the BG has a limited amount of turns and if actors in the BG do not achieve their objective(s) by then, alternate conditions may be used to determine the winner. In the example simplified BG, the scenarios were semi-randomly generated (description below) and both actors have the same objective. Each enemy unit killed is worth one victory point and the actor with the most points at the end of turn five is the winner.

The example implementation started with the BGs ruleset and further simplified the ruleset by limiting the action space and removing rules that referred to the actions that were eliminated, thus allowing the ruleset to focus exclusively on ground combat. The series rules from NW:Poland [Land, 2017], were used because they supersede any previous Series rules. The hex map, BG pieces, charts, etc. were taken from NW:Taiwan. Finally, the study removed any mechanics within the BG which were not directly necessary for a brief guerilla-style ground assault in order to simplify the sequence of actions. This allowed the study to entirely eliminate naval and air warfare, Initiative movement, Reinforcement, and Victory points. Instead, victory was determined by completion of a pre-specified condition.

The resulting simplified BG has the following structure: The weather is randomly initialized for the first BG turn, and the actors roll for weather on every subsequent turn, using the Weather Track provided with the BG. The first actor may move their units following the relevant ground movement rules, then engage in combat following the relevant combat rules. After the first actor completes their movement and combat, the second actor may engage in movement and combat. The study set an example win condition to be the elimination of the enemy army, so the BG ended after both actors had 5 turns or when either actor had no surviving units left.

One advantage of using NW:Taiwan for natural language reasoning is the complexity and, sometimes, the open-textured nature of its rules. For example, while the process to declare an attack is quite well defined, the actual term “attack” is not. The rules state: “The attacker declares the hex being attacked and indicates his attacking units.” Note that the hex is being attacked. Is it intended that actors may attack empty spaces, or is this an oversight? Does this mean that “If the defender's hex is vacant at the conclusion of combat . . . ” means combat can be used to generate additional movement? It may be difficult to recognize when a term that otherwise belongs to the genre of war BG s is representative of a BG mechanic or if it has an alternate meaning in the rules. Casualties, for instance, are supposed to capture a multitude of warfare facets and are even directly referenced on the developer's website: “As in many BGs, casualties represent not only actual combat losses but also losses of unit cohesion brought about by the rapid pace with which modern armies are able to engage and exploit on the battlefield” [gmt, 2023].

The dataset takes advantage of these open-textured rules to capture a wide range of BG play rule/state/action triads, and provide a rich collection of gold labeled data for action permissibility reasoning. If a reasoner, whether AI or human, is to effectively interpret open-textured rules, they must understand these rules within their intended context and align their judgement accordingly. This process mirrors the approach in the United States case law, where a judge may reference previous rulings to support decisions in novel situations. By presenting various actions, both allowed and disallowed, in different contexts, the example implementation can compel a reasoner (e.g., an AI system) to assess the same actions under varying circumstances. Successful reasoning across these contexts for identical actions, and doing so consistently, indicates that the reasoner possesses the capability to apply rules flexibly. This flexibility is crucial, as it enables the reasoner to adapt to scenarios where interpretations are not immediately apparent, reflecting a sophisticated level of understanding.

Utterances and Actions. The example dataset can include of triples: (S,α,c)

Where S is the current BG state, a large JSON object describing all hex positions on the board, the locations and properties of all units, and any other information that could potentially be used in determining whether an action is allowed.

c is a boolean describing whether the action α is allowed or disallowed. The action α consists of two parts: the utterance, which is the actual text spoken by the human actor to describe their action (e.g., “let's move the piece on 2434 to 2435 and then attack”); and the interpreted action. If the utterance corresponds to an allowed action, then the interpreted action will be a sequence of atomic actions, where an atomic action is a type of action that corresponds to a minimal decision that a actor can make (we have defined the set of possible atomic actions prior to dataset construction). An utterance is considered to be allowed if it corresponds straightforwardly to at least one sequence of allowed atomic moves.

Note that an utterance can require some detailed understanding of the rules and current BG state in order to determine whether there is a corresponding set of allowed atomic actions. For example, if a actor is in an attack phase, and they say the utterance “completely end my turn,” then the allowed sequence of atomic moves is to decline to attack, end the attack phase, and then end all subsequent phases in order. Utterances corresponding to disallowed actions may or may not have corresponding interpreted actions: simple utterances may unambiguously translate to a set of atomic actions which are disallowed (e.g., “move the unit on hex 2454 to 2554” may be disallowed if the piece has already moved this turn), or the utterance may be disallowed if there is no clear way to translate it into a set of atomic actions.

For this reason, the study can distinguish between actions that are disallowed because they do not correspond to any allowed atomic actions, and those which correspond to atomic actions which are against the rules. Herein, these are referred to as Disallowed by Scope (DSc), or Disallowed by State (DSt). DSc actions those whose impermissibility should be obvious to anyone with a shallow familiarity with the BG and its rules, and can be determined to be disallowed without even referring to the BG's current state. For example, the utterance “summon a sea monster to attack” can easily be seen as not allowed by the rules. DSt actions, in contrast, require both a deep knowledge of the rules and the ability to query the current state in order to determine they are illegal. In the previous example of moving an already-moved unit, the only way to know this action is allowed or disallowed would be to review the state immediately relevant to the action. It is though the distinction between DSc and DSt that we can determine if our algorithm is merely relying on accumulated knowledge from its training or if it possesses a deep understanding of the rules of the BG.

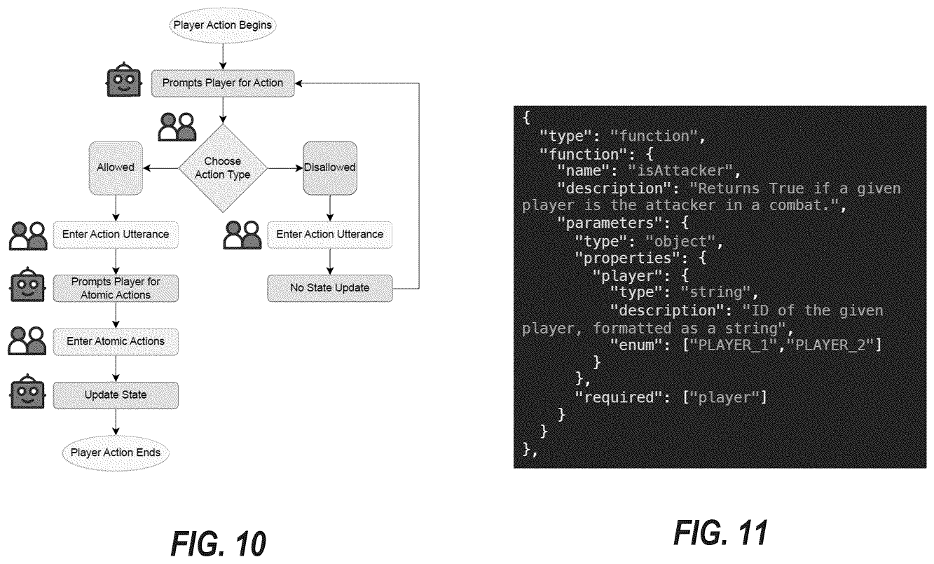

The action structure is graphically shown in FIG. 10. When actors declare actions, the scope is limited to atomic actions that the actors have control over. If a die needs to be rolled, or another actor needs to make a decision, then the uttered action must end before they hand off control. After all, it would not be much of a BG if an actor could declare a die roll in advance or instruct their opponent what to do. Combat is a common point where the actor must wait for outside information before continuing with their turn. The actor does not know how the dice will affect the outcome of combat, and so may not declare actions that extend past this point. Examples of compound and atomic actions are shown in FIG. 9.

Component encoding. Implementations of the present disclosure include component encoding. The procedure used to generate the dataset can divided into three stages: component declaration, BG play entry, and post processing. As the dataset was generated from actor actions during a BG, the physical components must be translated into a digital medium before being utilized. NW: Taiwan has four primary contents that must be digitized: units, board, actor aids, and rules.

To assist in data entry, the example implementation includes scripts to prompt for information on units and the hexagons that comprise the locations on the board. These are simple looping scripts that guide the user in entering the proper information and storing the information in JSON format. Some of the unit information options are hard coded to match the BG while others are string entries. This decision was made to ease entry for the Taiwan version specifically, but also allow for generalizations without too much editing. The NW:Taiwan BG has some vaguely defined instructions on how to treat terrain types that are only minimally present in a hex and so decided to include any features found on a hex in that hexes encoding. For example, if the art of a mountain range overlaps into a neighboring hex we counted the entire hex as having mountainous terrain. Once all of the hex information is encoded, areas between hexes are entered. For example, once hex A and B are entered, the study can then determine the properties shared along their border. Finally, a third script ingests all the hex encodings as well as their connection information to create an adjacency map.

Units, hexes, and adjacencies all utilized encodings to uniquely identify them. Encodings are a four or five digit identifier that uniquely refer to a hex or unit. The BG heavily relies on physical components to distinguish between pieces and so the study gave every unit, adjacency connection, and hex a unique encoding. Hexes are printed on the board and units are tokens that can be picked up and moved. Hexes contain the following information: The hex encoding, terrain type for movement and combat (mountainous, rough, urban, etc.), non-terrain features (bridges, fortifications, etc.), who controls the hex, and many other BG minutia. Units have similar information such as: encodings, which actor controls them, what faction or country they belong to, their attack/defense strength, current hex location (in encoding), movement points, etc.

The dataset also included the rules. While the other components concerned primitive data entry, the gameplay software responsible for assisting in rule compliance provides guidance to actors without strictly enforcing an interpretation of the rules. Otherwise, the software would be enforcing the programmers' understanding of the rules rather than allowing actors to make reasoned decisions. The software allows actors to enter utterances, allowed and disallowed actions, and update the state with atomic actions.

Scenario Generation. The dataset was developed using three actors familiar with the BG and its rules, generating actions over six BGs. There are 246 allowed actions and 268 disallowed actions, for a total of 532 actions. The standard of one allowed action per two disallowed was developed during development, so the ratio was not strictly kept at all points in time. To facilitate a diverse range of actions, the initial setup for each BG—referred to as scenarios—was pseudorandomly generated. To generate a scenario, one actor was randomly assigned between 5 and 10 units. The approximate strength of those units was defined as the sum of their movement allowances, combat strengths, and defenses. The other actor was then randomly assigned units one at a time until their approximate strength matched the initial actor's, in order to ensure a roughly balanced BG. A designated starting location was selected for each actor, and a joint ending location was selected for both actor. Each unit was then placed randomly within two hexes of its starting location. Because the board for NW:Taiwan is hex-based, each unit had up to six adjacent hexes. For each unit, a random adjacent hex was selected and, if allowed, the unit was relocated to that hex. Standard movement rules from the BG were followed, so units were not allowed to enter hexes containing an enemy unit, overstacked hexes, or hexes with prohibited terrains. To promote forward movement, units were also not allowed to enter hexes that they had already traversed. This random movement was repeated one hex at a time until the unit's movement allowance was depleted or the unit became stuck in a position that would be impassable without retreating through a traversed hex. This entire process of random hex selection and relocation until movement was depleted was considered one movement turn. Each unit stopped moving entirely when it arrived within two hexes of the ending location or had completed ten movement turns, whichever came first. These units, their final locations, and a randomly initialized weather pattern comprised the completed scenario.

Board Initialization. When a user begins the driver script, they are presented with an option to either start a new BG from a scenario or load a saved BG. In the case of a new BG, the scenario only contains information about the weather, what units are on the board, where they are, and who owns them. Once the scenario is chosen, this information is used to populate pandas dataframes containing information about hexes, adjacencies, and units mentioned above. In addition to that information, metagame details are also recorded. Metagame information concerns things such as current BG phase, scores, turn, combat information, actor actions, and many other programmatic details. In aggregate, these dataframes form what are referred to herein as the BG state. When a saved BG is loaded, the state is repopulated and the BG continues from that state. These files are formatted as JSON in order to easily reference and load individual dictionaries. As far as the BG driver is concerned, the only thing that matters is the line that contains the state the actor wishes to continue from, so using JSON lines allows us to strip out extraneous formatting. In either case, the actor who has the next decision to make is prompted for an action.

Data Entry. As a use of the dataset is to develop and evaluate an AI pipeline's ability to reason over rules, it can be beneficial to have a diverse range of labeled data. A BG as complex as NW:Taiwan can be used to generate such a diverse range of labeled data. The sheer volume of possible moves, along with randomization in the combat stage, makes static or repetitive BGs across randomly generated scenarios unlikely. To encourage diversity of actions the study chose to implement a two to one ratio of disallowed to allowed actions. Generally, actors will not attempt to wildly deviate from the rules of a BG, but what if they do not know the rules? In order to provide models with actions that are not in the scope of the BG, the study chose to have the first of the two disallowed actions to always be DSc. The second disallowed action is one that is DSt, such as a actor moving out of turn. This is graphically displayed in FIG. 10. Once the actor had entered two disallowed actions, they entered an allowed action. The actor did not try to force specific outcomes with these actions and played the BG as naturally as they could while avoiding overly repetitive actions.

### Experiment

The study included determining how well a state-of-the-art language model can solve the problems in the NW:T dataset, both when given only the rules of the BG, and when given previous examples of how to successfully solve problems. The study divided the dataset into three portions: a dev set (20 action-scenario pairs) a test set (40 action-scenario pairs, balanced across labels) and a train set (296 action-scenario pairs).

The example primary model was OpenAI's GPT-4 Turbo model, specifically gpt-4-1106-preview which allows for prompt sizes of up to 128 K tokens, and has a function calling API. The large prompt size allowed the study to include the entire rule set for the simplified version of NW:T. The function calling API allows us to send, as part of the prompts, a JSON object which contains a description of each function that we are making available to GPT-4 as shown in FIG. 11.

The functions made available were designed to allow the LM to access all information about the current BG state that it needed, without needing to directly access the JSON object representing the BG state. The dev set was used to ensure this set of functions was complete and debugged, and we restricted the set of functions to those that were primarily lookup functions—e.g., functions that retrieved information about the board, basic attributes of units, the current BG state, or information in lookup tables. Functions that required reasoning about the rules were not implemented, so that we could test the LMs' ability to do this.

The study used the train set to construct a shot bank that could be drawn upon later. The LM was prompted with the full rule set, and then “We want to perform the following action: ‘[action]’. Given the rules above, is the action legal or illegal? Work step-by-step, explaining your reasoning before giving your answer. Then, after you are done explaining your reasoning, if the action is legal, make the last word in your response ‘LEGAL’. Otherwise, write the last word in your response as ‘ILLEGAL’ and nothing else. If you need more information, use the provided function calls.” The LM was then allowed to make as many function calls as needed, until reaching a conclusion. If it reached the correct answer, then the action-scenario pair, along with the list of function calls made, and the rationale generated by the model for why its answer was correct, was added to the shot bank. If it didn't reach the correct answer after three attempts, the item-scenario pair was discarded. Within each of these attempts, if an error was encountered (e.g., an exception was generated due to an improperly formatted function call), then the error message was added to the prompt and the LM was allowed to continue. If the number of errors exceeded 3 in an attempt, then that attempt was abandoned. This resulted in a shot bank size of 203 items.

For the test set, the study provided the full rule set and JSON of available functions. Multiple conditions were then compared:

Shot count: The number of shots included in the prompt varied from 0 to 10.

Shot selection: We either used SBERT [Reimers and Gurevych, 2019] to select similar shots (as described above), or selected them randomly.

Function call and rationale inclusion: When including shots, we experimented with including the list of function calls that were successful in answering each shot, and including the rationale provided by the LM.

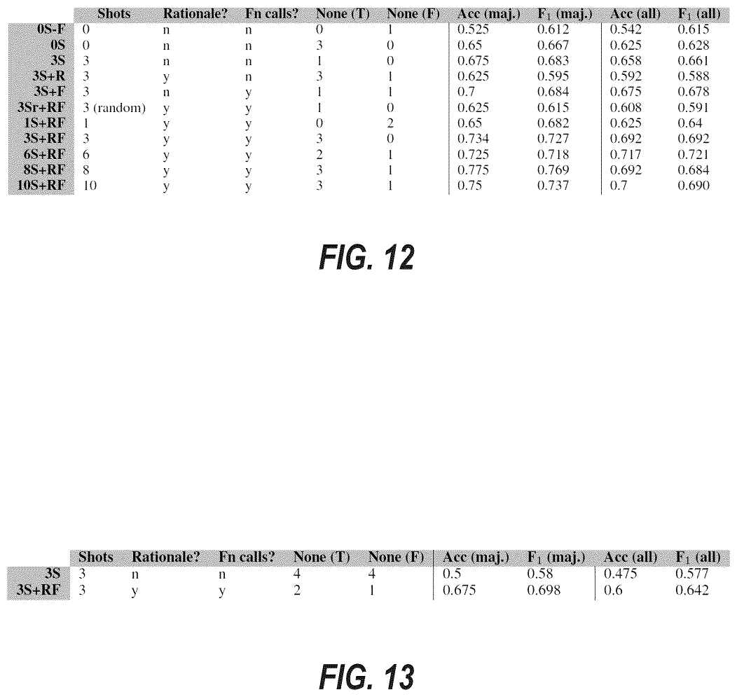

LM used: Unless otherwise stated, the study used OpenAI's gpt-4-1106-preview model, as it is at present the only LLM that both has a context size large enough to fit the entire ruleset and shots in its prompt, and has an API that natively supports function calling. For a few cases, the study also used gpt-3.5-turbo-1106. All results are listed in FIG. 12 (for GPT-4 results) and FIG. 13 (for GPT-3.5 results). For all of these conditions, the LM is given three attempts to solve the problem. The majority vote is considered its answer, but if there is no majority (due to errors or improperly formatted outputs, the number of which are in the “None” columns), then we consider the answer to be LEGAL.

Effects of shot sizes. Across all metrics, adding more shots seems to increase performance, until roughly 6 shots. After that, the benefits are no longer clear. Comparing 3Sr+RF (where shots are randomly chosen) and 3S+RF (where shots are chosen using SBERT), we see a substantial increase in performance, suggesting that the LM's improvement is not merely a matter of having more shots to provide examples of any BG-related reasoning—rather, having examples of how to perform reasoning that is similar to that likely to be used in the current problem is most helpful.

Effects of including function calls and rationales. There is a minimal positive increase in performance from 3S to 3S+F. However, the difference between 3S and 3S+R is actually negative, suggesting that the inclusion of rationales without examples of function calls actually harmed performance. However, 3S++RF again outperforms 3S+R and 3S+F.

Effects of LLM used. With GPT-3.5, 3S performed roughly at chance (FIG. 13), but was significantly improved with 3S+RF. Both conditions performed better with GPT-4, as expected.

Implementations of the present disclosure can not only include frameworks so that LMs can reason about action permissibility according to open-textured rules, but also frameworks that allow the LMs to justify their conclusions. And those justifications, ideally, would be in some form that acknowledges potential controversy or sources of interpretive disagreement where it exists, rather than ignoring it.

The study included a benchmark dataset for studying how well LMs can reason about action permissibility in realistic, complex, open-textured rule sets. The study introduced the methodology for creating this dataset, and showed that naïve querying of even state-of-the-art LMs like GPT-4 may result in no better than random behavior. More advanced prompting methods, such as those using 6 or more shots, along with example function calls and rationales as part of the shots, perform significantly better, but still do not surpass 80% accuracy.

Implementations of the present disclosure can further include providing different examples provided in the input shots, and generalizing the generalize the reasoning used by multiple shots to produce interpretable, repeatable procedures that can also be inspected by human experts.

### Example 3

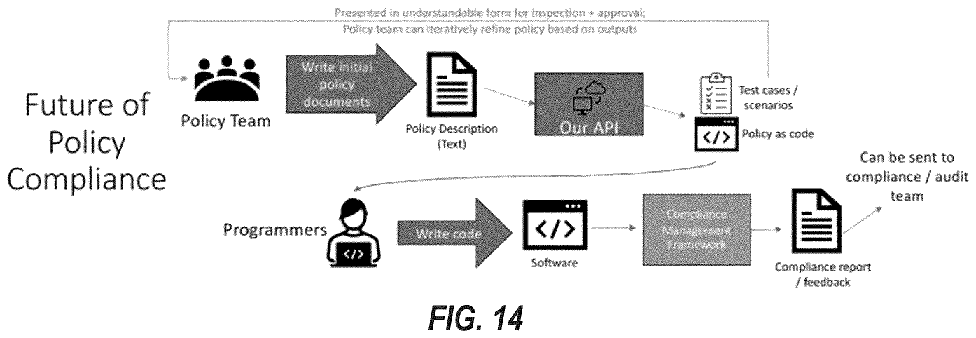

An example implementation of the present disclosure is configured to generate formal representations of written policies, regulations, or other rules and. The example implementation can include methods of (1) Converting the input into a coderich format using popular policy-as-code standards; (2) Ensuring that those translations into code are high-quality, tested, inspectable, understandable, etc.; and (3) Auto-generating compliance test cases. FIG. 14 illustrates an example implementation applied to software engineering. In the current dominant paradigm, policies or regulations are given to software engineers, often in the form of checklist-style spreadsheets. Engineers then enter a loop where they must write code, that code is examined for compliance by some audit team (sometimes referred to as the “trust” team), and they provide feedback or flag noncompliance, which must then be addressed by the engineers. This loop is slow, error-prone, frustrating, and costly.

In the example implementation, a policy team can use the systems and methods described herein to develop policies in the form of code-augmented policies. This makes policies easier for policy teams to communicate (optionally, the original text version of the policies are not replaced by code, but accompanied by them), easier for programmers to understand, and for both policy enforcement and compliance checking to be carried out more efficiently across the entire software development cycle. Thus communications and interpretations of the text (e.g., the policies/regulations) are streamlined and efficient.

It should be appreciated that the logical operations described herein with respect to the various figures may be implemented (1) as a sequence of computer implemented acts or program modules (i.e., software) running on a computing device (e.g., the computing device described in FIG. 15), (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

Referring to FIG. 15, an example computing device 1500 upon which the methods described herein may be implemented is illustrated. It should be understood that the example computing device 1500 is only one example of a suitable computing environment upon which the methods described herein may be implemented. Optionally, the computing device 1500 can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, computing device 1500 typically includes at least one processing unit 1506 and system memory 1504. Depending on the exact configuration and type of computing device, system memory 1504 may be volatile (such as random access memory (RAM)), non-volatile (such as read-only memory (ROM), flash memory, etc.), or some combination of the two. This most basic configuration is illustrated in FIG. 15 by dashed line 1502. The processing unit 1506 may be a standard programmable processor that performs arithmetic and logic operations necessary for operation of the computing device 1500. The computing device 1500 may also include a bus or other communication mechanism for communicating information among various components of the computing device 1500.

Computing device 1500 may have additional features/functionality. For example, computing device 1500 may include additional storage such as removable storage 1508 and non-removable storage 1510 including, but not limited to, magnetic or optical disks or tapes. Computing device 1500 may also contain network connection(s) 1516 that allow the device to communicate with other devices. Computing device 1500 may also have input device(s) 1514 such as a keyboard, mouse, touch screen, etc. Output device(s) 1512 such as a display, speakers, printer, etc. may also be included. The additional devices may be connected to the bus in order to facilitate communication of data among the components of the computing device 1500. All these devices are well known in the art and need not be discussed at length here.

The processing unit 1506 may be configured to execute program code encoded in tangible, computer-readable media. Tangible, computer-readable media refers to any media that is capable of providing data that causes the computing device 1500 (i.e., a machine) to operate in a particular fashion. Various computer-readable media may be utilized to provide instructions to the processing unit 1506 for execution. Example tangible, computer-readable media may include, but is not limited to, volatile media, non-volatile media, removable media and non-removable media implemented in any method or technology for storage of information such as computer readable instructions, data structures, program modules or other data. System memory 1504, removable storage 1508, and non-removable storage 1510 are all examples of tangible, computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 1506 may execute program code stored in the system memory 1504. For example, the bus may carry data to the system memory 1504, from which the processing unit 1506 receives and executes instructions. The data received by the system memory 1504 may optionally be stored on the removable storage 1508 or the non-removable storage 1510 before or after execution by the processing unit 1506.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

### REFERENCES

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.
Adler, A. 2019. Keeping the law of magic: The gathering. Escapist Magazine.
Araszkiewicz, M. 2021. Critical questions to argumentation schemes in statutory interpretation. Journal of Applied Logics—IfCoLog Journal of Logics and Their Applications 8(1).
Bench-Capon, T. J. M., and Sergot, M. J. 1985. Towards a rule-based representation of open texture in law. In Walter, C., ed., Computer Power and Legal Language: The Use of Computational Linguistics, Artificial Intelligence, and Expert Systems in the Law.
Brown, T. B.; Mann, B.; Ryder, N.; Subbiah, M.; Kaplan, J.; Dhariwal, P.; Neelakantan, A.; Shyam, P.; Sastry, G.; Askell, A.; Agarwal, S.; Herbert-Voss, A.; Krueger, G.; Henighan, T.; Child, R.; Ramesh, A.; Ziegler, D. M.; Wu, J.; Winter, C.; Hesse, C.; Chen, M.; Sigler, E.; Litwin, M.; Gray, S.; Chess, B.; Clark, J.; Berner, C.; McCandlish, S.; Radford, A.; Sutskever, I.; and Amodei, D. 2020. Language models are few-shot learners.
Chen, M.; Tworek, J.; Jun, H.; Yuan, Q.; de Oliveira Pinto, H. P.; Kaplan, J.; Edwards, H.; Burda, Y.; Joseph, N.; Brockman, G.; Ray, A.; Puri, R.; Krueger, G.; Petrov, M.; Khlaaf, H.; Sastry, G.; Mishkin, P.; Chan, B.; Gray, S.; Ryder, N.; Pavlov, M.; Power, A.; Kaiser, L.; Bavarian, M.; Winter, C.; Tillet, P.; Such, F. P.; Cummings, D.; Plappert, M.; Chantzis, F.; Barnes, E.; Herbert-Voss, A.; Guss, W. H.; Nichol, A.; Paino, A.; Tezak, N.; Tang, J.; Babuschkin, I.; Balaji, S.; Jain, S.; Saunders, W.; Hesse, C.; Carr, A. N.; Leike, J.; Achiam, J.; Misra, V.; Morikawa, E.; Radford, A.; Knight, M.; Brundage, M.; Murati, M.; Mayer, K.; Welinder, P.; McGrew, B.; Amodei, D.; McCandlish, S.; Sutskever, I.; and Zaremba, W. 2021. Evaluating large language models trained on code.
Chvatal, V. 1979. A greedy heuristic for the set-covering problem. Mathematics of Operations Research 4(3):233235.
Evtikhiev, M.; Bogomolov, E.; Sokolov, Y.; and Bryksin, T. 2022. Out of the bleu: how should we assess quality of the code generation models?
Franklin, J. 2012. Discussion paper: How Much of Commonsense and Legal Reasoning is Formalizable? A Review of Conceptual Obstacles. Law, Probability and Risk 11(23):225-245.
García-Sánchez, P.; Tonda, A.; Mora, A. M.; Squillero, G.; and Merelo, J. J. 2018. Automated playtesting in collectible card games using evolutionary algorithms: A case study in hearthstone. Knowledge-Based Systems 153:133-146.
Grad, L. 2017. Helping AI to play hearthstone using neural networks. In Ganzha, M.; Maciaszek, L.; and Paprzycki, M., eds., Proceedings of the Federated Conference on Computer Science and Information Systems, 131-134. Institute of Electrical and Electronic Engineers.
Hart, H. 1961. The Concept of Law. Clarendon Press.
Hoover, A. K.; Togelius, J.; Lee, S.; and de Mesentier Silva, F. 2020. The many AI challenges of hearthstone. KI Künstliche Intelligenz (Artificial Intelligence) 34:33-43.
Klasiński, L.; Meller, W.; and Witkowski, M. 2020. Implementation of Collectible Card Game AI with Opponent Prediction. Ph.D. Dissertation, University of Wrocław.
Kowalski, J., and Miernik, R. 2018. Legends of code and magic.
Kowalski, J., and Miernik, R. 2020. Evolutionary approach to collectible arena deckbuilding using active card game genes. In 2020 IEEE Congress on Evolutionary Computation (CEC), 1-8. Institute of Electrical and Electronic Engineers.
Licato, J.; Marji, Z.; and Abraham, S. 2019. Scenarios and recommendations for ethical interpretive ai. In Proceedings of the AAAI 2019 Fall Symposium on Human-Centered AI.
Licato, J. 2021. How Should AI Interpret Rules? A Defense of Minimally Defeasible Interpretive Argumentation. arXiv e-prints.
Licato, J. 2022a. Automated Ethical Reasoners Must be Interpretation-Capable. In Proceedings of the AAAI 2022 Spring Workshop on “Ethical Computing: Metrics for Measuring AI's Proficiency and Competency for Ethical Reasoning”.
Licato, J. 2022b. War-gaming needs argument-justified ai more than explainable ai. In Sen, A., ed., Proceedings of the XAISG Special Track on Explainable AI in Societal Games.
Ling, W.; Blunsom, P.; Grefenstette, E.; Hermann, K. M.; Kočiský, T.; Wang, F.; and Senior, A. 2016. Latent predictor networks for code generation. In Proceedings of the 54th Annual Meeting of the Association for Computational Linguistics (Volume 1: Long Papers), 599-609. Berlin, Germany: Association for Computational Linguistics.
Miernik, R., and Kowalski, J. 2022. Evolving evaluation functions for collectible card game AI. In Proceedings of the 14th International Conference on Agents and Artificial Intelligence (ICAART 2022), volume 3, 253-260.
Poesia, G.; Polozov, O.; Le, V.; Tiwari, A.; Soares, G.; Meek, C.; and Gulwani, S. 2022. SYNCHROMESH: Reliable code generation from pre-trained language models.
Prakken, H. 2017. On the problem of making autonomous vehicles conform to traffic law. Artificial Intelligence and Law 25(3):341-363.
Quandt, R., and Licato, J. 2020. Problems of Autonomous Agents following Informal, Open-textured Rules. In Law-less, W. F.; Mittu, R.; and Sofge, D. A., eds., HumanMachine Shared Contexts. Academic Press.
Rajkumar, N.; Li, R.; and Bahdanau, D. 2022. Evaluating the text-to-SQL capabilities of large language models.
Ren, S.; Guo, D.; Lu, S.; Zhou, L.; Liu, S.; Tang, D.; Sundaresan, N.; Zhou, M.; Blanco, A.; and Ma, S. 2020. Codebleu: a method for automatic evaluation of code synthesis. CoRR abs/2009.10297.
Sanders, K. E. 1991. Representing and reasoning about open-textured predicates. In Proceedings of the 3rd International Conference on AI and Law (ICAIL '91), 137-144.
Sartor, G.; Walton, D.; Macagno, F.; and Rotolo, A. 2014. Argumentation schemes for statutory interpretation: A logical analysis. In Legal Knowledge and Information Systems. (Proceedings of JURIX 14), 21-28.
Scholak, T.; Schucher, N.; and Bahdanau, D. 2021. PICARD: Parsing incrementally for constrained autoregressive decoding from language models. In Moens, M. F.; Huang, X.; Specia, L.; and tau Yih, S. W., eds., Proceedings of the 2021 Conference on Empirical Methods in Natural Language Processing, 9895-9901. Association for Computational Linguistics.
Trummer, I. 2022. CodexDB: synthesizing code for query processing from natural language instructions using GPT-3 codex. Proceedings of the VLDB Endowment 15(11):29212928.
Vecht, J. J. 2020. Open texture clarified. Inquiry 0(0):1-21. Waismann, F. 1965. The Principles of Linguistic Philosophy. St. Martins Press.
Walton, D.; Macagno, F.; and Sartor, G. 2021. Statutory Interpretation: Pragmatics and Argumentation. Cambridge University Press.
Walton, D.; Sartor, G.; and Macagno, F. 2018. Statutory interpretation as argumentation. In Bongiovanni, G.; Postema, G.; Rotolo, A.; Sartor, G.; Valentini, C.; and Walton, D., eds., Handbook of Legal Reasoning and Argumentation. Dordrecht: Springer Netherlands. 519-560.
Ward, H. N.; Mills, B.; Brooks, D. J.; Troja, D.; and Khakhalin, A. S. 2021. AI solutions for drafting in Magic: the Gathering. In 2021 IEEE Conference on Games (CoG), 1-8. Institute of Electrical and Electronic Engineers.
Zhang, Y.; Fontaine, M. C.; Hoover, A. K.; and Nikolaidis, S. 2022. Deep surrogate assisted MAP-elites for automated hearthstone deckbuilding. In Fieldsend, J. E., ed., GECCO '22: Proceedings of the Genetic and Evolutionary Computation Conference, 158-167. Association for Computing Machinery.
Zhong, M.; Liu, G.; Li, H.; Kuang, J.; Zeng, J.; and Wang, M. 2022. CodeGen-Test: An automatic code generation model integrating program test information.
Zhong, R.; Yu, T.; and Klein, D. 2020. Semantic evaluation for text-to-SQL with distilled test suites. In Webber, B.; Cohn, T.; He, Y.; and Liu, Y., eds., Proceedings of the 2020 Conference on Empirical Methods in Natural Language Processing, 396-411. Association for Computational Linguistics.
[Bai et al., 2022] Yuntao Bai, Saurav Kadavath, Sandipan Kundu, Amanda Askell, Jackson Kernion, Andy Jones, Anna Chen, Anna Goldie, Azalia Mirhoseini, Cameron Mckinnon, Carol Chen, Catherine Olsson, Christopher Olah, Danny Hernandez, Dawn Drain, Deep Ganguli, Dustin Li, Eli Tran-Johnson, Ethan Perez, Jamie Kerr, Jared Mueller, Jeffrey Ladish, Joshua Landau, Kamal Ndousse, Kamile Lukosuite, Liane Lovitt, Michael Sellitto, Nelson Elhage, Nicholas Schiefer, Noemi Mercado, Nova DasSarma, Robert Lasenby, Robin Larson, Sam Ringer, Scott Johnston, Shauna Kravec, Sheer El Showk, Stanislav Fort, Tamera Lanham, Timothy Telleen-Lawton, Tom Conerly, Tom Henighan, Tristan Hume, Samuel R. Bowman, Zac Hatfield-Dodds, Ben Mann, Dario Amodei, Nicholas Joseph, Sam McCandlish, Tom Brown, and Jared
Kaplan. Constitutional ai: Harmlessness from ai feedback, 2022.
[bgg, 2023] Next war: Taiwan, November 2023.
[Franklin, 2012] James Franklin. Discussion paper: How Much of Commonsense and Legal Reasoning is Formalizable? A Review of Conceptual Obstacles. Law, Probability and Risk, 11(2-3):225-245, June-September 2012.
[gmt, 2023] Gmt games-next war: Taiwan 2nd edition, November 2023.
[Hart, 1961] H. L. A. Hart. The Concept of Law. Clarendon Press, 1961.
[Land, 2014] Mitchell Land. Next war: Taiwan, 2014.
[Land, 2017] Mitchell Land. Next war: Poland, 2017.
[Licato and Marji, 2018] John Licato and Zaid Marji. Probing formal/informal misalignment with the loophole task. In Proceedings of the 2018 International Conference on Robot Ethics and Standards (ICRES 2018), 2018.
[Licato et al., 2019] John Licato, Zaid Marji, and Sophia Abraham. Scenarios and recommendations for ethical interpretive ai. In Proceedings of the AAAI 2019 Fall Symposium on Human-Centered AI, Arlington, V A, 2019.
[Licato, 2021] John Licato. How Should AI Interpret Rules? A Defense of Minimally Defeasible Interpretive Argumentation. arXiv e-prints, 2021.
[Prakken, 2017] Henry Prakken. On the problem of making autonomous vehicles conform to traffic law. Artificial Intelligence and Law, 25(3):341-363, September 2017.
[Quandt and Licato, 2020] Ryan Quandt and John Licato. Problems of Autonomous Agents following Informal, Open-textured Rules. In William F. Lawless, Ranjeev Mittu, and Donald A. Sofge, editors, Human-Machine Shared Contexts. Academic Press, 2020.
[Rebedea et al., 2023] Traian Rebedea, Razvan Dinu, Makesh Sreedhar, Christopher Parisien, and Jonathan Cohen. Nemo guardrails: A toolkit for controllable and safe 1 Im applications with programmable rails, 2023.
[Reimers and Gurevych, 2019] Nils Reimers and Iryna Gurevych. Sentence-BERT: Sentence embeddings using Siamese BERT-networks. In Kentaro Inui, Jing Jiang, Vincent Ng, and Xiaojun Wan, editors, Proceedings of the 2019 Conference on Empirical Methods in Natural Language Processing and the 9th International Joint Conference on Natural Language Processing (EMNLP-IJCNLP), pages 3982-3992, Hong Kong, China, November 2019. Association for Computational Linguistics.
[Waismann, 1965] Friedrich Waismann. The Principles of Linguistic Philosophy. St. Martins Press, 1965.

What is claimed:

1. A computer-implemented method comprising:
receiving a plurality of text strings;
generating a plurality of formal strings using a large language model (LLM), wherein each of the plurality of formal strings correspond to a text string of the plurality of text strings;
generating a plurality of relationships that relate the plurality of formal strings; and
generating, based on the plurality of formal strings and the plurality of relationships, a mapping of the plurality of formal strings.

2. The computer-implemented method of claim 1, wherein the plurality of formal strings comprise computer program code.

3. The computer-implemented method of claim 1, further comprising displaying the mapping of the plurality of formal strings.

4. The computer-implemented method of claim 3, wherein displaying the mapping of the plurality of formal strings comprises displaying a flowchart, wherein the flowchart represents the plurality of relationships that relate the plurality of formal strings.

5. A computer-implemented method comprising:
receiving a text string;
generating, using a first machine learning model, a plurality of feature values for the text string, wherein the plurality of feature values correspond to attributes of the text string;
inputting the text string and the plurality of feature values into a second machine learning model; and
generating, using the second machine learning model, a formal representation of the text string.

6. The computer-implemented method of claim 5, wherein the first machine learning model comprises a lightweight model.

7. The computer-implemented method of claim 5, wherein the first machine learning model comprises a machine learning model fine-tuned to identify application programing interface (API) features.

8. The computer-implemented method of claim 5, wherein the first machine learning model comprises a lightweight large language model.

9. The computer-implemented method of claim 5, wherein the first machine learning model is less complex than the second machine learning model.

10. The computer-implemented method of claim 5, wherein the second machine learning model comprises a large language model.

11. The computer-implemented method of claim 5, wherein the plurality of feature values comprise API functions.

12. The computer-implemented method of claim 5, wherein the first machine learning model comprises a computational language model.

13. A computer-implemented method of responding to natural language queries comprising:
deploying a trained large language model, wherein the trained large language model is trained on a corpus of a plurality of formal strings and a plurality of text strings, wherein each of the plurality of formal strings correspond to a text string of the plurality of text strings;
receiving a natural language query;
determining, using the trained large language model based on the natural language query, a formal answer, wherein the formal answer corresponds to a text string of the plurality of text strings.

14. The computer-implemented method of claim 13, further comprising generating display data for the formal answer to the natural language query.

15. The computer-implemented method of claim 13, further comprising generating display data for the text string of the plurality of text strings.

16. The computer-implemented method of claim 13, wherein the formal answer further comprises a formal string of the plurality of formal strings that corresponds to the formal answer to the natural language query.

17. The computer-implemented method of claim 13, wherein the trained large language model is fine-tuned on a rule set.

18. The computer-implemented method of claim 13, wherein the formal strings comprise logical outputs.

19. The computer-implemented method of claim 13, wherein the natural language query comprises a request to determine whether a formal string of the plurality of formal strings is related to the natural language query.

20. The computer-implemented method of claim 13, wherein the formal strings comprise computer code.
